(19) United States
(12) Patent Application Publication
(10) Pub. No.: US 2010/0102984 A1
(43) Pub. Date: Apr. 29, 2010

(54) REMOTE CONTROLLER AND COMMUNICATION COMBINED USE DIGITAL BROADCASTING TRANCEIVER FOR PERFORMING VOICE OR IMAGE COMMUNICATION, METHOD AND SYSTEM THEREFOR

(75) Inventors: IN-SEONG HWANG, Seoul (KR); KIM HOOJONG, Seoul (KR)

Correspondence Address: David A. Einhorn, Esq.;Baker & Hostetler LLP, 45 Rockefeller Plaza, New York, NY, 10111, US

(73) Assignee: SK TELECOM CO., LTD., Seoul (KR)

(21) Appl. No.: 12/615,845

(22) Filed: Nov. 10, 2009

Related U.S. Application Data
(63) Continuation of application No. PCT/KR2008/003158, filed on Jun. 5, 2008.

(30) Foreign Application Priority Data
Jun. 11, 2007 (KR) 10-2007-0056895

(51) Int. Cl. H04B 1/20

(52) U.S. Cl. 340/825.25

(57) ABSTRACT

The present invention relates to a remote controller and a communication-capable digital broadcasting receiver for voice or image communication, a system including the remote controller and the digital broadcasting receiver, and a method thereof.

### TECHNICAL FIELD

The present invention relates to a remote controller and a communication-capable digital broadcasting receiver for voice or image communication, a system including the remote controller and the digital broadcasting receiver, and a method thereof. More particularly, the present invention relates to a remote controller and a communication-capable digital broadcasting receiver for voice or image communication, and a method and system for the same, which enable the user to perform voice or image communication through the remote controller in such a manner that, when the remote controller cooperating with the communication-capable digital broadcasting receiver through the local-area communication units receives a signal of a specified key for receiving voice or image communication, the remote controller and the communication-capable digital broadcasting receiver shift their audio output paths from an external audio output to a local-area communication output at the same time by means of a remote-controller local-area communication unit equipped on the remote controller and a receiver local-area communication unit equipped on the communication-capable digital broadcasting receiver.

### BACKGROUND ART

Recently, with the development of electronics and communication technology, digital broadcasting receivers, such as a set-top box, which receives a digital broadcast from the Internet, a satellite, etc. and outputs a broadcast program through an image and audio output medium such as a TV, have been developed and put on the market.

Generally, the digital broadcasting receivers have been developed and marketed in a form integrated with a general TV or the like, or as separate receivers to be used through connection with a TV, and are convenient apparatuses that enable the user to easily view a video-on-demand (VOD) or real-time digital broadcasts in the home.

In addition, recently, with the development of electronics and communication technology, mobile communication technology has come into wide use, so that communication-capable digital broadcasting receivers, capable of performing communication, receiving and reproducing digital broadcasts, and reproducing stored digital data by using the mobile communication technology, have been developed and increasingly used.

FIG. 1 is a block diagram schematically illustrating the configuration of a conventional communication-capable digital broadcasting receiving system.

The conventional digital broadcasting receiving system includes a content providing unit 110, a wired/wireless communication network 120, and a communication-capable digital broadcasting receiver 130.

The content providing unit 110 corresponds to a server for a broadcast program provider, which generates a broadcast program as digital data and broadcasts the digital data through the wired/wireless communication network 120, and includes servers or satellites for broadcasting providers, who provide Internet broadcasting, digital multimedia broadcasting (DMB), and Internet protocol TV (IPTV) broadcasting.

The wired/wireless communication network 120 represents a network, such as an Internet network, an intranet network, a mobile communication network, a satellite communication network, etc., which can transmit/receive data according to Internet protocol by using various wired/wireless communication technologies.

The communication-capable digital broadcasting receiver 130 has voice communication and voice communication functions, and also can receive and reproduce digital broadcasts or can reproduce stored digital data. For example, the communication-capable digital broadcasting receiver 130 may be one among a mobile terminal, a smart phone, a personal digital assistant (PDA), a portable multimedia player (PMP), and an Internet protocol television) IPTV set-top box.

The communication-capable digital broadcasting receiver 130 includes a wired/wireless communication unit 140, a receiver storage unit 142, a receiver input unit 144, a receiver control unit 150, a receiver decoding unit 160, a receiver output unit 162, and a wireless communication processing unit 170.

The wired/wireless communication unit 140 is a communication means for receiving digital data from the content providing unit 110 through the wired/wireless communication network 120, and the receiver control unit 150 is a control means for controlling the entire operation of the communication-capable digital broadcasting receiver 130 and controlling data and signals in the communication-capable digital broadcasting receiver 130.

The receiver storage unit 142 is a storage means, such as a flash memory, a hard disk, a CD-ROM, a DVD, etc., for storing data, and the receiver input unit 144 is a wired/wireless input means, such as a keyboard, a mouse, a joystick, a gamepad, etc., for receiving instructions and data to control the communication-capable digital broadcasting receiver 130.

The receiver decoding unit 160 is a reproduction means for generating image and audio signals, by decoding received digital data when the receiver decoding unit 160 receives either digital data received through the wired/wireless communication unit 140 or digital data stored in the receiver storage unit 142 by the receiver control unit 150.

The receiver output unit 162 is an output means for outputting an image and audio through a screen and speaker included in the communication-capable digital broadcasting receiver 130, or transmitting image and audio signals to an external image/audio output device so that a corresponding image and audio can be output through the external image/audio output device, when the communication-capable digital broadcasting receiver 130 is connected to the external image/audio output device.

The wireless communication processing unit 170 is a wireless communication processing means for processing wireless communication, in such a manner as to perform a digital signal processing function of coding/decoding voice signals, performing an equalizing operation for removing multipath noise, and processing audio data, to perform a baseband conversion function of converting a received signal or a signal to be transmitted into a baseband signal, performing a digital-to-analog conversion, and performing an analog-to-digital conversion, to perform a radio frequency (RF) signal processing function of receiving an RF signal, converting the received RF signal into an intermediate frequency (IF) signal, converting an IF signal into an RF signal, and demodulating and amplifying an RF signal, and to perform an antenna function of transmitting/receiving a wireless signal over the air.

The operation procedure of the communication-capable digital broadcasting receiver 130 having the aforementioned construction will now be described. When the user selects to receive a real-time digital broadcast by the receiver input unit 144, the wired/wireless communication unit 140 receives digital data from the content providing unit 110 and transfers the received digital data to the receiver control unit 150. Then, the receiver control unit 150 transfers the digital data to the receiver decoding unit 160, and the receiver decoding unit 160 generates image and audio signals by decoding the digital data, and outputs an image and audio through the receiver output unit 162.

Also, when viewing of a VOD is selected and contents to be viewed by the user are selected by the user through the receiver input unit 144, the wired/wireless communication unit 140 receives digital data from the content providing unit 110 and transfers the received digital data to the receiver control unit 150. Then, the receiver control unit 150 stores the digital data in the receiver storage unit 142, and transfers the digital data stored in the receiver storage unit 142 to the receiver decoding unit 160. The receiver decoding unit 160 generates image and audio signals by decoding the digital data, and outputs an image and audio through the receiver output unit 162.

In addition, the receiver control unit 150 performs a basic function of voice or image communication according to signals input from the receiver input unit 144 or the wireless communication processing unit 170.

However, when the convention communication-capable digital broadcasting receiver 130 is requested to respond to a voice or image communication while the convention communication-capable digital broadcasting receiver 130 is receiving and reproducing a digital broadcast through a TV connected thereto, or is reproducing stored digital data through the TV, the communication-capable digital broadcasting receiver 130 can perform a voice or image communication only through the speaker of the connected TV.

That is, when the communication-capable digital broadcasting receiver 130 is requested to respond to voice or image communication while the user is viewing of a digital broadcast together with many persons, it is difficult for the user to make a personal communication, thereby causing considerable inconvenience to users. Therefore, it is necessary to develop technology for removing such inconvenience.

### DISCLOSURE

### Technical Solution

Therefore, the present invention has been made in view of the above-mentioned problems, and it is an object of the present invention to provide a remote controller and a communication-capable digital broadcasting receiver for voice or image communication, a system including the remote controller and the digital broadcasting receiver, and a method thereof, which enable the user to perform voice or image communication through the remote controller in such a manner that, when the remote controller cooperating with the communication-capable digital broadcasting receiver through the local-area communication units receives a signal of a specified key for receiving voice or image communication, the remote controller and the communication-capable digital broadcasting receiver shift their audio output paths from an external audio output to a local-area communication output at the same time by means of a remote-controller local-area communication unit equipped on the remote controller and a receiver local-area communication unit equipped on the communication-capable digital broadcasting receiver.

In order to achieve the above-mentioned object, there is provided a system for receiving a voice or image communication signal through a wired/wireless communication network, and receiving and outputting digital data for a digital broadcast provided from a content providing unit, the system including: a communication-capable digital broadcasting receiver for shifting a receiver audio output path from an external audio output to a receiver local-area communication output, when the communication-capable digital broadcasting receiver receives the voice or image communication signal while receiving and transferring the digital data from the content providing unit through the wired/wireless communication network; and a remote controller for shifting a remote-controller audio output path from an external audio output to a remote-controller local-area communication output when the remote controller receives a signal of a specified key for a communication request, and outputting only a voice signal after receiving the voice or image communication signal from the digital broadcasting receiver.

According to another aspect of the present invention, there is provided a method for receiving a voice or image communication system through a wired/wireless communication network, and receiving and reproducing digital data for a digital broadcast from a content providing unit, the method employing a communication-capable digital broadcasting receiver and a remote controller, the method including the steps of: (a) receiving, by the communication-capable digital broadcasting receiver, the voice or image communication signal; (b) shifting, by the remote controller, a remote-controller audio output path from an external audio output to a local-area communication output when receiving a signal of a specified key for a communication request; (c) transmitting, by the remote controller, a communication request signal to the communication-capable digital broadcasting receiver; (d) determining, by the communication-capable digital broadcasting receiver, if the communication-capable digital broadcasting receiver is receiving the digital data from the content providing unit and is outputting the digital data; (e) shifting, by the communication-capable digital broadcasting receiver, a receiver audio output path from an external audio output to a receiver local-area communication output, when the communication-capable digital broadcasting receiver is outputting the digital data as a result of the determination of step (d); (f) transmitting, by the communication-capable digital broadcasting receiver, the voice or image communication signal to the remote controller; and (g) outputting, by the remote controller, only the voice signal after the voice or image communication signal.

According to still another aspect of the present invention, there is provided a communication-capable digital broadcasting receiver for receiving a voice or image communication signal through a wired/wireless communication network, receiving digital data for a digital broadcast provided from the content providing unit, and outputting the received digital data, the communication-capable digital broadcasting receiver including: a wired/wireless communication unit for receiving the digital data from the content providing unit via the wired/wireless communication network; a wireless communication processing unit for receiving the voice or image communication signal through the wired/wireless communication network, and then performing a process for a wireless communication function; a receiver local-area communication unit for performing data communication using local-area communication; an infrared receiving unit for receiving a signal using an infrared ray; and a receiver control unit for controlling all functions of the communication-capable digital broadcasting receiver, receiving the voice or image communication signal from the wireless communication processing unit, determining if the communication-capable digital broadcasting receiver is receiving in control of the wired/wireless communication unit when receiving a communication request signal from a remote controller, and controlling a receiver audio output path to shift from an external output to a receiver local-area communication output when the communication-capable digital broadcasting receiver is receiving the digital data as a result of the determination.

According to another aspect of the present invention, there is provided a remote controller for receiving a voice or image communication signal, the remote controller including: a remote-controller local-area communication unit for performing data communication using local-area communication; an infrared transmitting unit for transmitting a signal using an infrared ray; a remote-controller input unit for receiving a signal of a specified key for a communication request; and a remote-controller control unit for shifting a remote-controller audio output path from an external audio output to a remote-controller local-area communication output, and controlling the remote-controller local-area communication unit to receive a voice or image communication signal from the communication-capable digital broadcasting receiver when receiving the signal of the specified key from the remote-controller input unit.

### DESCRIPTION OF DRAWINGS

FIG. 1 is a block diagram schematically illustrating the configuration of a conventional communication-capable digital broadcasting receiving system;

FIG. 2 is a block diagram schematically illustrating the configuration of a remote controller for performing voice or image communication according to an exemplary embodiment of the present invention; and

FIG. 3 is a flowchart illustrating the operation procedure of the remote controller performing voice or image communication according to an exemplary embodiment of the present invention.

### MODE FOR INVENTION

Hereinafter, one exemplary embodiment of the present invention will be described with reference to the accompanying drawings. It is to be noted that the same elements are indicated with the same reference numerals throughout the drawings. In the following description, a detailed description of known functions and configurations incorporated herein will be omitted when it may make the subject matter of the present invention rather unclear.

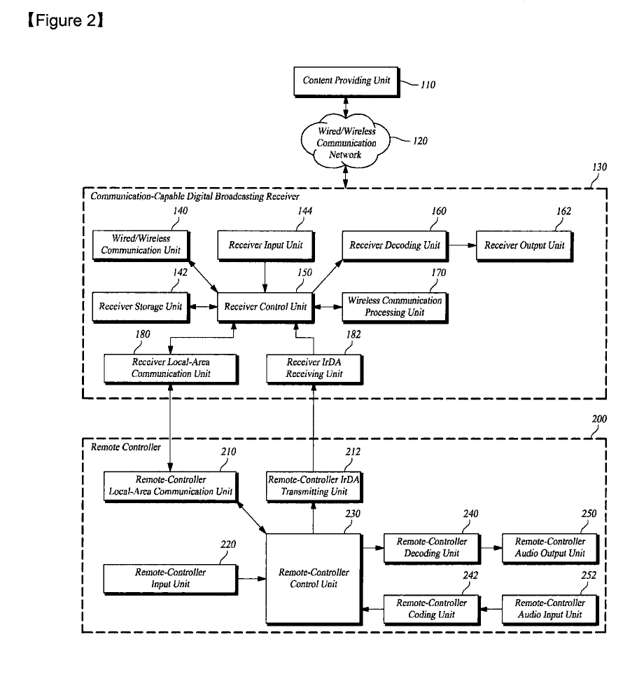

FIG. 2 is a block diagram schematically illustrating the configuration of a remote controller for performing voice or image communication according to an exemplary embodiment of the present invention.

A remote controller system for performing voice or image communication according to an exemplary embodiment of the present invention includes a content providing unit 110, a wired/wireless communication network 120, a communication-capable digital broadcasting receiver 130, and a remote controller 200.

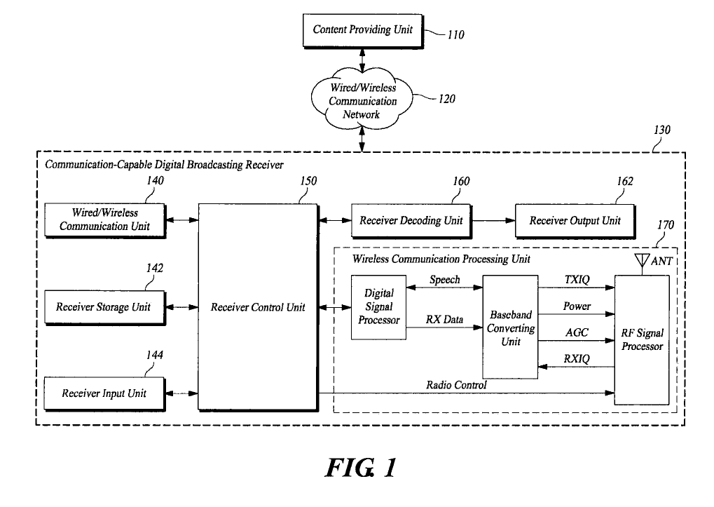

Here, since the configurations of the content providing unit 110 and the wired/wireless communication network 120 have been described above with reference to FIG. 1, a detailed description thereof will be omitted.

The communication-capable digital broadcasting receiver 130 has voice communication and voice communication functions, and also can receive and reproduce digital broadcasts or can reproduce stored digital data. For example, the communication-capable digital broadcasting receiver 130 may be one among a mobile terminal, a smart phone, a personal digital assistant (PDA), a portable multimedia player (PMP), and an Internet protocol television) IPTV set-top box. For convenience of description, an embodiment of the present invention will be described on the assumption that the communication-capable digital broadcasting receiver 130 is an IPTV set-top box which is separately manufactured and is connected to a TV so as to receive a digital broadcast.

According to an exemplary embodiment of the present invention, the communication-capable digital broadcasting receiver 130 includes a wired/wireless communication unit 140, a receiver storage unit 142, a receiver input unit 144, a receiver control unit 150, a receiver decoding unit 160, a receiver output unit 162, a wireless communication processing unit 170, a receiver local-area communication unit 180, and an infrared receiving unit 182.

Here, the configurations of the wired/wireless communication unit 140, the receiver storage unit 142, the receiver input unit 144, the receiver decoding unit 160, the receiver output unit 162, and the wireless communication processing unit 170 are identical or similar to those described with reference to FIG. 1, so a detailed description thereof will be omitted.

The receiver control unit 150 according to an exemplary embodiment of the present invention performs not only the function described with reference to FIG. 1, but also a function of receiving a voice or image communication signal from the wireless communication processing unit 170.

When receiving a communication request signal through the infrared receiving unit 182 from the remote controller 200, the receiver control unit 150 determines if there is digital data being input and output through the wired/wireless communication unit 140 and the receiver decoding unit 160 under the control of the receiver control unit 150.

When there is output digital data as a result of the determination, the receiver control unit 150 shifts a receiver's audio output path from an external audio output to a receiver's local-area communication output, and performs a function of controlling the receiver local-area communication unit 180 to transfer the voice or image communication signal.

The receiver local-area communication unit 180 is a communication means for performing data communication with a remote-controller local-area communication unit 210 of the remote controller 200 so as to connect the communication-capable digital broadcasting receiver 130 and the remote controller 200 to each other. The receiver local-area communication unit 180 may perform data communication through a universal serial bus (USB), serial communication, ultra wide band (UWB) communication, Institute of Electrical and Electronics Engineers (IEEE) 1394, Mobile Display Digital Interface (MDDI), Bluetooth, etc., which include all wired/wireless communication schemes.

The infrared receiving unit 182 is a communication means for receiving an infrared ray from an infrared transmitting unit 212 of the remote controller 200 to connect the communication-capable digital broadcasting receiver 130 and the remote controller 200 to each other, and is implemented in an Infrared Data Association (IrDA) scheme.

The remote controller 200 according to an exemplary embodiment of the present invention includes the remote-controller local-area communication unit 210, the infrared transmitting unit 212, a remote-controller input unit 220, a remote-controller control unit 230, a remote-controller decoding unit 240, a remote-controller coding unit 242, a remote-controller audio output unit 250, and a remote-controller audio input unit 252.

The remote-controller local-area communication unit 210 is a communication means for receiving digital data from the receiver local-area communication unit 180 and transferring the digital data by performing data communication with the receiver local-area communication unit 180 of the communication-capable digital broadcasting receiver 130 to connect the remote controller 200 and the communication-capable digital broadcasting receiver 130 to each other. The remote-controller local-area communication unit 210 performs both wired and wireless communication, like the aforementioned receiver local-area communication unit 180.

The infrared transmitting unit 212 is a communication means for converting data input from the remote-controller input unit 220 into an infrared ray and transmitting the infrared ray to the infrared receiving unit 182 of the communication-capable digital broadcasting receiver 130 so as to connect the communication-capable digital broadcasting receiver 130 and the remote controller 200 to each other.

The remote-controller input unit 220 is an input means for receiving instructions or data to control the remote controller 200 from the user, and includes not only a keypad and a touch screen, but also all types of input means for receiving instructions and data from an external device through a USB or serial communication.

The remote-controller control unit 230 is a control means for controlling the entire operation of the remote controller 200 and controlling data and signals of the remote controller 200.

The remote-controller decoding unit 240 is a decoding means for receiving digital data for voice and image communication from the remote-controller control unit 230, and decoding the received digital data to generate an audio signal.

The remote-controller coding unit 242 performs a function of coding digital data received from the remote-controller audio input unit 252, and transmitting the coded digital data to the remote-controller control unit 230.

The remote-controller audio output unit 250 is an audio output means of the remote controller 200, and performs a function of converting an audio signal received from the remote-controller decoding unit 240 into an analog signal, and outputting the analog signal through a speaker included in the remote-controller audio output unit 250.

The remote-controller audio input unit 252 performs a function of receiving a user voice, converting analog voice data into digital voice data, and transmitting the digital voice data to the remote-controller coding unit 242.

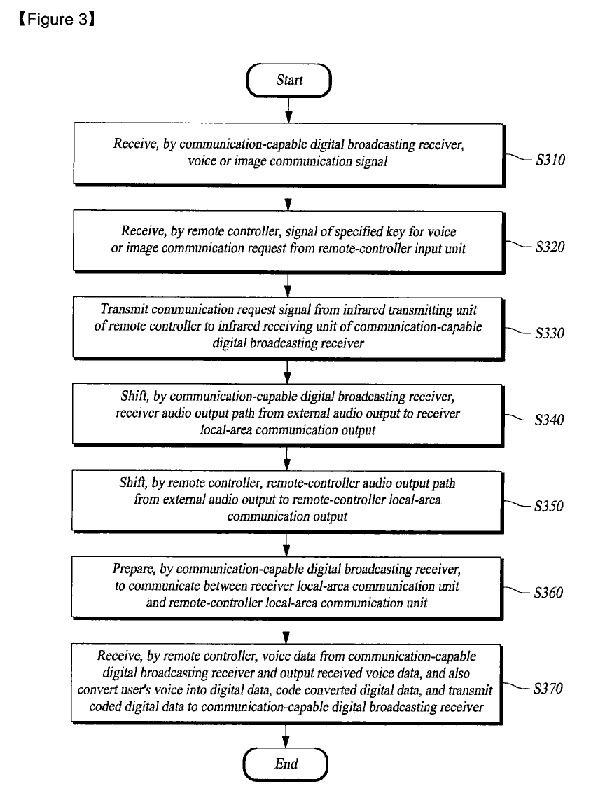

FIG. 3 is a flowchart illustrating the operation procedure of the remote controller performing voice or image communication according to an exemplary embodiment of the present invention.

The wireless communication processing unit 170 of the communication-capable digital broadcasting receiver 130 receives a voice or image communication signal from the wired/wireless communication network 120, and transmits the voice or image communication signal to the receiver control unit 150 (step 310).

The remote-controller control unit 230 of the remote controller 200 receives a signal of a specified key to make communication from the remote-controller input unit 220 in order to receive the voice or image communication signal from the communication-capable digital broadcasting receiver 130 (step 320).

The remote-controller control unit 230 of the remote controller 200 controls the infrared transmitting unit 212 to transmit a communication request signal to request voice or image communication to the infrared receiving unit 182 of the communication-capable digital broadcasting receiver 130 (step 330).

The receiver control unit 150 of the communication-capable digital broadcasting receiver 130 shifts an audio output path from an external audio output to a receiver local-area communication output (step 340).

That is, the receiver control unit 150 of the communication-capable digital broadcasting receiver 130 controls a power supply circuit (not shown) to supply power to the receiver local-area communication unit 180.

The remote-controller control unit 230 of the remote controller 200 shifts a remote-controller audio output path from an external audio output to a remote-controller local-area communication output (step 350).

That is, the remote-controller control unit 230 of the remote controller 200 controls a power supply circuit (not shown) to supply power to all or some of the remote-controller local-area communication unit 210, the remote-controller decoding unit 240, the remote-controller coding unit 242, the remote-controller audio output unit 250, and the remote-controller audio input unit 252.

When the receiver control unit 150 of the communication-capable digital broadcasting receiver 130 receives a communication request signal through the infrared receiving unit 182, the receiver control unit 150 controls the receiver local-area communication unit 180 to prepare to communicate with the remote-controller local-area communication unit 210 of the remote controller 200 (step 360).

The remote-controller control unit 230 of the remote controller 200 receives a voice or image communication signal from the receiver local-area communication unit 180 of the communication-capable digital broadcasting receiver 130 by controlling the remote-controller local-area communication unit 210, and outputs only the voice signal to the remote-controller audio output unit 250, and also the remote-controller control unit 230 receives analog voice data of the user from the remote-controller audio input unit 252, converts the analog voice data into digital voice data, codes the digital voice data by means of the remote-controller coding unit 242, and transmits the coded digital voice data to the communication-capable digital broadcasting receiver 130 (step 370).

That is, when communication is performed, the remote-controller control unit 230 of the remote controller 200 receives audio data from the remote-controller local-area communication unit 210 and transmits the audio data to the remote-controller decoding unit 240, and then the remote-controller decoding unit 240 reproduces and outputs an audio signal to the remote-controller audio output unit 250. Also, when communication is performed, the remote-controller audio input unit 252 receives the voice of the user, the remote-controller coding unit 242 codes the voice to digital data and transmits the coded digital data to the remote-controller control unit 230, and then the remote-controller control unit 230 controls the remote-controller local-area communication unit 210 to the coded digital data to the receiver local-area communication unit 180 of the communication-capable digital broadcasting receiver 130.

Although an exemplary embodiment of the present invention has been described for illustrative purposes, those skilled in the art will appreciate that various modifications, additions and substitutions are possible, without departing from the scope and spirit of the invention as disclosed in the accompanying claims. Therefore, the embodiment disclosed in the present invention has been described not for limiting the scope of the invention, but for describing the invention. Accordingly, the scope of the invention is not to be limited by the above embodiment but by the claims and the equivalents thereof. It will be understood by those skilled in the art that various changes in form and details may be made therein without departing from the spirit and scope of the invention as defined by the appended claims.

### INDUSTRIAL APPLICABILITY

As described above, according to the present invention, when the remote controller cooperating with the communication-capable digital broadcasting receiver through the local-area communication units receives a signal of a specified key for receiving voice or image communication, the remote controller and the communication-capable digital broadcasting receiver shift their audio output paths from an external audio output to a local-area communication output at the same time by means of the remote-controller local-area communication unit equipped on the remote controller and the receiver local-area communication unit equipped on the communication-capable digital broadcasting receiver, so that it is possible to perform voice or image communication.

Also, when the remote controller receives voice or image communication, the remote-controller audio output path of the remote controller is shifted from an external audio output to a remote-controller local-area communication output, and simultaneously, the receiver audio output path of the communication-capable digital broadcasting receiver is shifted from an external audio output to a receiver local-area communication output, so that it is not required for one local-area communication module between the remote controller and the communication-capable digital broadcasting receiver to continuously operate, thereby preventing power (i.e. battery power) from being continuously consumed.

Also, in view of the user, when received voice or image communication is received by the remote controller while the user is viewing a digital broadcast through the communication-capable digital broadcasting receiver, the user can easily perform voice or image communication through use of a specified key for a communication request, which is included in the remote controller, even without additionally adjusting other keys of the remote controller.

1. A system for receiving a voice or image communication signal through a wired/wireless communication network, and receiving and outputting digital data for a digital broadcast provided from a content providing unit, the system comprising:
a communication-capable digital broadcasting receiver for shifting a receiver audio output path from an external audio output to a receiver local-area communication output, when the communication-capable digital broadcasting receiver receives the voice or image communication signal while receiving and transferring the digital data from the content providing unit through the wired/wireless communication network; and
a remote controller for shifting a remote-controller audio output path from an external audio output to a remote-controller local-area communication output when the remote controller receives a signal of a specified key for a communication request, and outputting only a voice signal after receiving the voice or image communication signal from the digital broadcasting receiver.

2. A method for receiving a voice or image communication system through a wired/wireless communication network, and receiving and reproducing digital data for a digital broadcast from a content providing unit, the method employing a communication-capable digital broadcasting receiver and a remote controller, the method comprising the steps of:
(a) receiving, by the communication-capable digital broadcasting receiver, the voice or image communication signal;
(b) shifting, by the remote controller, a remote-controller audio output path from an external audio output to a local-area communication output when receiving a signal of a specified key for a communication request;
(c) transmitting, by the remote controller, a communication request signal to the communication-capable digital broadcasting receiver;
(d) determining, by the communication-capable digital broadcasting receiver, if the communication-capable digital broadcasting receiver is receiving the digital data from the content providing unit and is outputting the digital data;
(e) shifting, by the communication-capable digital broadcasting receiver, a receiver audio output path from an external audio output to a receiver local-area communication output, when the communication-capable digital broadcasting receiver is outputting the digital data as a result of the determination of step (d);
(f) transmitting, by the communication-capable digital broadcasting receiver, the voice or image communication signal to the remote controller; and
(g) outputting, by the remote controller, only the voice signal after the voice or image communication signal.

3. A communication-capable digital broadcasting receiver for receiving a voice or image communication signal through a wired/wireless communication network, receiving digital data for a digital broadcast provided from the content providing unit, and outputting the received digital data, the communication-capable digital broadcasting receiver comprising:
a wired/wireless communication unit for receiving the digital data from the content providing unit via the wired/wireless communication network;
a wireless communication processing unit for receiving the voice or image communication signal through the wired/wireless communication network, and then performing a process for a wireless communication function;
a receiver local-area communication unit for performing data communication using local-area communication;
an infrared receiving unit for receiving a signal using an infrared ray; and
a receiver control unit for controlling all functions of the communication-capable digital broadcasting receiver, receiving the voice or image communication signal from the wireless communication processing unit, determining if the communication-capable digital broadcasting receiver is receiving in control of the wired/wireless communication unit when receiving a communication request signal from a remote controller, and controlling a receiver audio output path to shift from an external output to a receiver local-area communication output when the communication-capable digital broadcasting receiver is receiving the digital data as a result of the determination.

4. The communication-capable digital broadcasting receiver as claimed in claim 3, further comprising:
a receiver decoding unit for decoding the digital data to generate an image signal and an audio signal; and
a receiver output unit for outputting the image signal and the audio signal.

5. The communication-capable digital broadcasting receiver as claimed in claim 3, further comprising a receiver storage unit for storing the digital data.

6. The communication-capable digital broadcasting receiver as claimed in claim 3, wherein the receiver local-area communication unit uses at least one scheme among a universal serial bus (USB), serial communication, ultra wide band (UWB) communication, Institute of Electrical and Electronics Engineers (IEEE) 1394, Mobile Display Digital Interface (MDDI), and Bluetooth.

7. A remote controller for receiving a voice or image communication signal, the remote controller comprising:
a remote-controller local-area communication unit for performing data communication using local-area communication;
an infrared transmitting unit for transmitting a signal using an infrared ray;
a remote-controller input unit for receiving a signal of a specified key for a communication request; and
a remote-controller control unit for shifting a remote-controller audio output path from an external audio output to a remote-controller local-area communication output, and controlling the remote-controller local-area communication unit to receive a voice or image communication signal from the communication-capable digital broadcasting receiver when receiving the signal of the specified key from the remote-controller input unit.

8. The remote controller as claimed in claim 7, further comprising:
a remote-controller decoding unit for decoding the voice or image communication signal to generate an audio signal;
a remote-controller coding unit for receiving and coding analog voice data into digital voice data;
a remote-controller audio output unit for outputting the audio signal; and
a remote-controller audio input unit for receiving and transferring the analog voice data.

9. The remote controller as claimed in claim 7, wherein the receiver local-area communication unit uses at least one scheme among a universal serial bus (USB), serial communication, ultra wide band (UWB) communication, Institute of Electrical and Electronics Engineers (IEEE) 1394, Mobile Display Digital Interface (MDDI), and Bluetooth.
